(19) United States
(12) Patent Application Publication
(10) Pub. No.: US 2008/0207049 A1
(43) Pub. Date: Aug. 28, 2008

(54) Nanocone silicone gel for telecommunication interconnect devices

(76) Inventors: Ziwei Liu, Fort Worth, TX (US); Paul Joseph Huspeni, Keller, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/712,272

(22) Filed: Feb. 28, 2007

(51) Int. Cl. H01R 33/945; C08K 5/541

(52) U.S. Cl. 439/577; 29/592; 524/261

(57) ABSTRACT

A silicone-based gel for use with telecommunication interconnect devices. The silicone gel includes roughly equal Parts A and B by weight or volume. Part A includes (i) between about 15 to 20 parts vinyl terminated polydimethyl siloxane of non-agglomerated SiO₂ (nanocone) nanoparticles, (ii) between about 80 to 85 parts unmodified polydimethylsiloxane, and (iii) between about 0.1 to 0.3 parts of approximately 0.5% platinum catalyst. Part B includes (i) between about 5 to 10 parts vinyl terminated polydimethyl siloxane of non-agglomerated SiO₂ (nanocone) nanoparticles, (ii) between about 15 to 30 parts hydride terminated polydimethylsiloxane, (iii) between about 0.2 to 10 parts hydride functional polydimethylsiloxane, and (iv) between about 50 to 80 parts unmodified polydimethylsiloxane. A telecommunication interconnect device that uses the silicone gel is also disclosed.

### BACKGROUND OF THE INVENTION

1. Field of the Invention

The present invention relates to gels and sealants used to protect telecommunication equipment from the environment, and in particular relates to a nanocone-based silicone gel suited for protecting telecommunication interconnect devices used in telecommunication systems.

2. Technical Background

A gel is a colloidal suspension of cross-linked particles dispersed in a liquid. Silicone-based gels are used as a sealant to protect telecommunication devices, such as telecommunication interconnect devices, from environmental effects that can degrade equipment performance. Such gels need to have certain viscoelastic properties such as toughness, adhesion, elongation and cohesive strength, to adequately perform their function. Formulating such a gel having the needed properties is a challenge because some of the properties are difficult to achieve in one gel.

By controlling the amount of cross-linkage in the gel, its viscoelastic properties can be balanced over a wide temperature and shear frequency range. However, as certain telecommunication devices include electrical connectors such as insulation displacement connectors (IDCs), it is necessary that the gel be extremely pliable (i.e., have low hardness) so that it will not cause significant resistance to the motion of the IDCs and the wire connection. This is particularly important in telecommunication interconnect devices where the environmental protection afforded by the gel needs to be maintained over repeated connections.

To reduce the resistance to the motion offered by the gel when wire connections are made in a telecommunication interconnect device, the gel needs to be thin and pliable. This requires that the amount of chemical cross-linkage in the gel be relatively small. However, this small cross-linkage results in a gel with poor viscoelastic properties and low toughness. These mutually exclusive properties have prevented the development of a silicone gel suitable for use as a sealant in certain telecommunication devices such as telecommunication interconnect devices used to make repeated connections in the field.

### SUMMARY OF THE INVENTION

One aspect of the present invention is directed to a silicone gel for use with a telecommunication device such as a telecommunication interconnect device. The silicone gel is constituted by roughly equal amounts (by weight or volume) of two main parts, Part A and Part B. Part A includes (i) between about 15 to 20 parts vinyl terminated polydimethyl siloxane of non-agglomerated SiO₂ (nanocone) nanoparticles, (ii) between about 80 to 85 parts unmodified polydimethylsiloxane, and (iii) between about 0.1 to 0.3 parts of approximately 0.5% platinum catalyst. Part B includes (i) between about 5 to 10 parts vinyl terminated polydimethyl siloxane of non-agglomerated SiO₂ (nanocone) nanoparticles, (ii) between about 15 to 30 parts hydride terminated polydimethylsiloxane, (iii) between about 0.2 to 10 parts hydride functional polydimethylsiloxane, and (iv) between about 50 to 80 parts unmodified polydimethylsiloxane.

Another aspect of the invention is a telecommunication interconnect device such as used in telecommunication systems, wherein the telecommunication interconnect device is adapted to make an electrical connection with at least one conducting wire. The device includes a housing that defines at least one interior chamber. At least one electrical connection member is at least partially disposed within the at least one interior chamber. The device also includes the silicone gel as described immediately above and contained within at least a portion of the at least one interior chamber such that the gel contacts the at least one electrical connecting member.

Another aspect of the invention is a method of manufacturing a telecommunication interconnect device for connecting one or more conducting wires. The method includes providing a device housing that defines at least one interior chamber, and providing at least one electrical connection member at least partially within the at least one interior chamber, wherein the electrical connection member is adapted to provide an electrical connection with the one or more wires. The method also includes inserting the silicone gel as described above within at least a portion of the at least one interior chamber such that the silicone gel contacts at least a portion of the at least one electrical connection member.

Additional features and advantages of the invention are set out in the detailed description which follows, and in part will be readily apparent to those skilled in the art from that description or recognized by practicing the invention as described herein, including the detailed description which follows, as well as the appended drawings.

It is to be understood that both the foregoing general description and the following detailed description present exemplary embodiments of the invention, and are intended to provide an overview or framework for understanding the nature and character of the invention as it is claimed, and not for reasons of limitation. The accompanying drawings are included to provide a further understanding of the invention and are incorporated into and constitute a part of this specification. The drawings illustrate various embodiments of the invention, and together with the detailed description, serve to explain the principles and operations thereof, and are not provided for reasons of limitation.

### BRIEF DESCRIPTION OF THE DRAWINGS

FIG. 1 is a plot of the elastic and viscous components of the shear modulus (G′ and G″, respectively) in dynes/cm², as a function of the shear frequency ω in rads/s for the silicone gel of the present invention, illustrating that the silicone gel has well-balanced viscoelastic properties over a large shear-frequency range;

FIG. 2 is a plot similar to FIG. 1, illustrating the viscoelastic properties of both “hard” (higher G′, G″ values) and “soft” (lower G′, G″ values) formulations for a conventionally-formed silicone gel, illustrating the deterioration of the viscoelastic properties when the conventionally formed silicone gel is made thinner (softer);

FIG. 3 is a plot similar to FIGS. 1 and 2, illustrating the viscoelastic properties of both “hard” (higher G′, G″ values) and “soft” (lower G′, G″ values) formulations of the silicone gel of the present invention, illustrating that both types of formulations maintain their viscoelastic properties over a wide frequency range;

FIG. 4 is a schematic interior view of a universal network interface device (NID) that includes a telecommunication interconnect device according to the present invention;

FIG. 5 is an enlarged partial cut-way view of the telecommunication interconnect device of FIG. 4, showing the silicone gel of the present invention contained in the customer-bridge chamber and the stuffer box chamber; and

FIG. 6 is a close-up cross-sectional end-on view of a customer bridge similar to that of the telecommunication interconnect device of FIG. 5, showing the service-provider-side and customer-side sections of the customer-bridge chamber filled with the silicone gel of the present invention, and also showing an example electrical connector member in the form of an insulation displacement connector (IDC) that resides in both chambers and that is immersed in the silicone gel.

### DETAILED DESCRIPTION OF THE INVENTION

Reference is now made in detail to several exemplary embodiments of the invention, and examples of which are illustrated in the accompanying drawings. Whenever possible, the same reference numerals are used throughout the drawings to refer to the same or like parts.

### General Description of the Silicone Gel

The present invention is directed to a family of novel silicone gel formulations that employ so-called “nanocone” vinyl silicone raw material. Unlike traditional silicone raw materials having long-chain polymers, nanocone materials have nanometer-sized silica particles chemically linked in the silicone matrix. The use of nanoparticles in the silicone gel of the present invention provides the gel with superior viscoelastic properties and toughness, as well as a relatively small amount of chemical cross-linkage that makes the gel suitably thin and pliable. This allows the gel to provide little resistance to the motion of electrical connection members such as insulation displacement connectors (IDCs) when making wire connections, while at the same time providing the necessary viscoelastic properties that provide suitable environmental protection for variety of telecommunication devices, particularly those that employ copper wires and/or optical fibers.

The silicone gel of the present invention has nanometer-size silica particles chemically linked in the silicone matrix. This provides the gel with two major advantages over conventionally formed silicone gels. The first is the reinforcement of material mechanical strength, tear strength, and toughness akin to that obtained in conventional silicone gels by adding reinforcement fillers. However, adding reinforcement fillers is costly and makes the manufacturing process less efficient. Because standard filler particles are relatively large, the resultant mixture is usually not stable and makes the gel opaque. On the other hand, silica nanoparticles are invisible because they are smaller than the wavelength of visible light. The resultant silicone gel thus has the clarity of water. Also, the smallness of the silica nanoparticles provides for a very strong reinforcement effect.

The second advantage is that the silicone gel of the present invention becomes more elastic even with the reduced chemical cross-linkage. This is important because, as mentioned before, a thin gel formulation requires much less chemical cross-linking, which normally results in poor viscoelastic properties and lack of toughness. By including nanocone materials in the silicone gel of the present invention, the gel remains thin while possessing well-balanced viscoelastic properties and good toughness even with relatively little permanent chemical cross-linking.

### Silicone Gel Formulation

The silicone gel of the present invention is formulated using two main Parts, referred to herein as Part A and Part B, with approximately a one-to-one by weight (or volume) mixing ratio of Part A to Part B. Example constituents for Parts A and Parts B are provided in respective Tables A and B, below. The range for the constituent parts in the Tables below is properly interpreted herein as being “between about x and y,” where x is lower-limit of the parts range and y is the upper limit of the parts range.

TABLE A
CONSTITUENTS OF PART A

| constituent | parts | example |
|---|---|---|
| Vinyl terminated polydimethyl siloxane OF non- | 15–20 | 18.1 |
| agglomerated SiO₂ nanoparticles (Nanocone VN) | | |
| Unmodified polydimethylsiloxane | 80–85 | 81.7 |
| Platinum Catalyst (~0.5%) | 0.1–0.3 | 0.2 |
| Gamma-Glycidoxypropyltrimethoxysilane (optional) | <1 | — |

TABLE B
CONSTITUENTS OF PART B

| Constituent | Parts | Example |
|---|---|---|
| Vinyl terminated polydimethyl siloxane of non- | 5–10 | 7.8 |
| agglomerated SiO₂ nanoparticles (Nanocone VN) | | |
| Hydride terminated polydimethylsiloxane | 15–30 | 18.1 |
| Hydride functional polydimethylsiloxane | 0.2–10 | 0.4 |
| Unmodified polydimethylsiloxane | 50–80 | 73.7 |

Mechanical properties of the silicone gel of the present invention are presented in Table C, below:

TABLE C
MECHANICAL PROPERTIES

| Base Chemistry | Nanosilicone gel |
|---|---|
| Mix ratio (by volume or weight) | 1 A:1 B |
| Pot life @ 25° C. | ~15 min |
| Tensile Stress at break (kPa) | 7.76 |
| Elongation (%) | 1082–1140 |
| Mean elongation (%) | 1124 |
| Cone penetrometer [¼-scale cone] reading | 94 |
| (tenths of a mm) | |

A tensile test was performed using a modified ASTM D638 method. Standard Type IV 115 mm long, 3 mm thick tensile test bars were made by mixing and casting the silicone gel in a Teflon mold containing Type IV tensile bar cavities. The resultant gel samples were cured for at least 24 hours at room temperature to achieve the best test specimens. The tensile properties were measured using an Instron Universal Testing Machine. The Instron cross-head speed employed was 101.6 mm/minute and the grip distance was set to 50.8 mm. A cone penetrometer equipped with a ¼-scale cone (ASTM method 1403-02) was utilized to provide a measure of inverse gel hardness.

The 25° C. pot life of various formulations of the silicone gel was measured using the ARES parallel plate rheometer. The ARES curing curve for the silicone gel was analyzed and the intersection of extrapolated baseline and s-shaped curing curve tangents was selected as the pot life.

### Silicone Gel Viscoelastic Properties

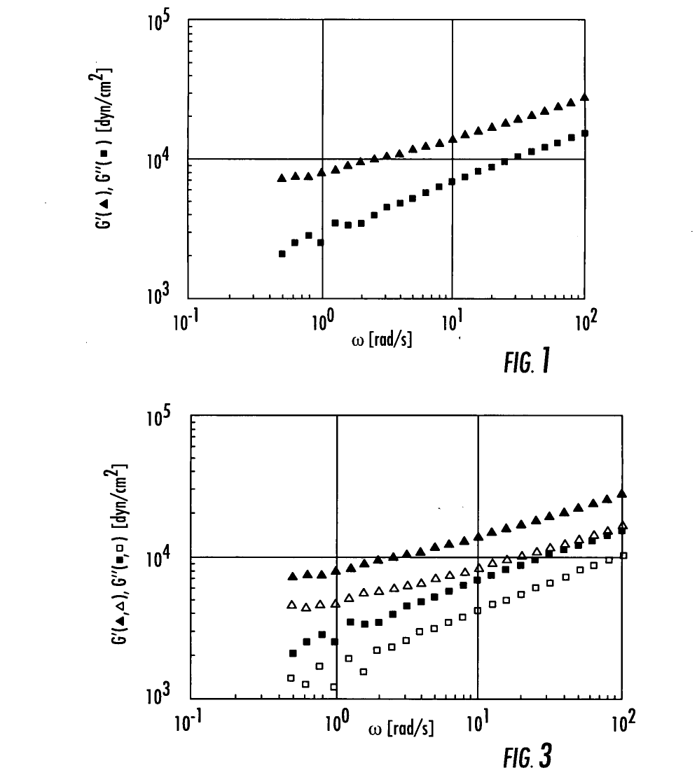

The viscoelastic properties of the gel were characterized using the ARES rotational rheometer and are shown in the plot of FIG. 1. The parameter G′ is the elastic component of the shear modulus, and G″ is the viscous portion (both measured in dynes/cm²). Shear frequency co (measured in rads/s) correlates with how rapidly the gel is strained during wire termination in a telecommunication interconnect device. The performance of a gel under these conditions is solely governed by the viscoelastic properties. From FIG. 1, it can be seen that the silicone gel has well-balanced viscoelastic properties over the entire frequency range, evidenced by the fact that changes in G′ and G″ vs. frequency ω are substantially parallel.

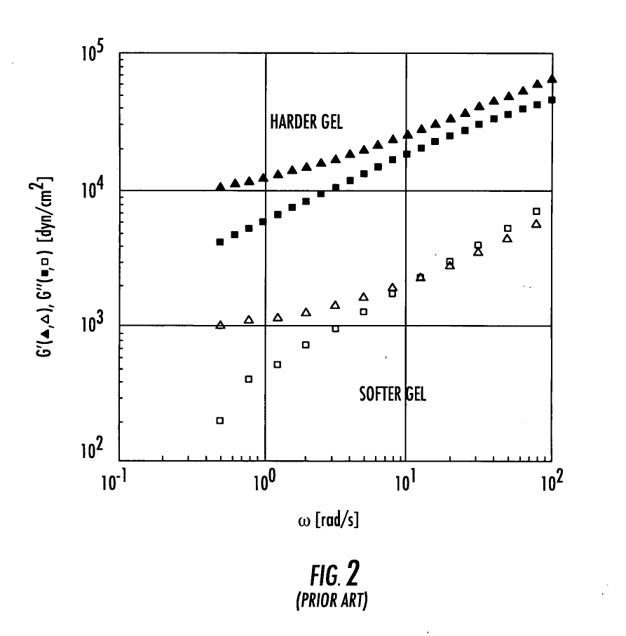

FIG. 2 is a plot of viscoelastic properties for a conventionally formulated silicone gel. The harder formulation (higher G′, G″ values) exhibits a relatively good balance of viscoelastic properties. The respective offset of the G′ and G″ moduli remains fairly constant for this harder gel as a function of shear frequency—a desirable condition for consistent end-use performance. However, when the conventional gel is made thinner (softer) using a traditional silicone-based formulation, the viscoelastic properties deteriorate, resulting in poor toughness, tear resistance, and cohesive strength. Such a gel is unsuitable for most telecommunication device applications, such as for IDC modules, that undergo repeated lever actuation and wire termination.

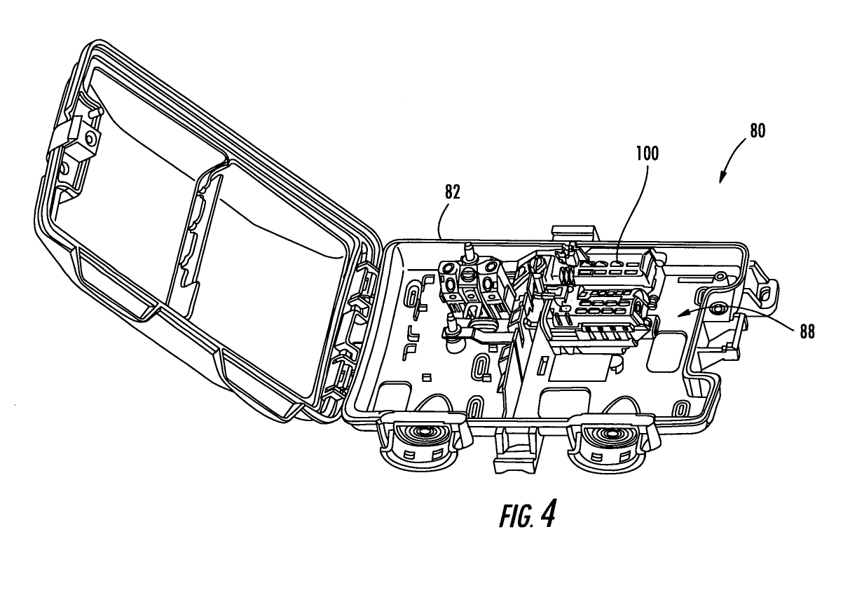

FIG. 3 is a plot similar to FIG. 2 but for hard and soft formulations of the silicone gel of the present invention. FIG. 3 indicates that when the gel of the present invention is formulated to be thinner and more pliable (thus offering less resistance to module lever motion and wire termination in an IDC module), the viscoelastic properties remain unchanged over a wide shear frequency range.

Telecommunication Interconnect Device with Silicone Gel

An aspect of the present invention is the silicone gel of the present invention used in a telecommunication interconnect device for telecommunication systems, wherein the device includes at least one electrical conducting member and connects conducting wires (e.g., copper subscriber and provider wiring) of the system. In another example embodiment, the silicone gel of the present invention is used in a telecommunication interconnect device to pot additional telecommunication lines or cables, including optical fibers and optical cables, such as disclosed in U.S. patent application Ser. No. 11/172,094 filed Jun. 30, 2005, which application is assigned to the present assignee and which application is incorporated in its entirety by reference herein.

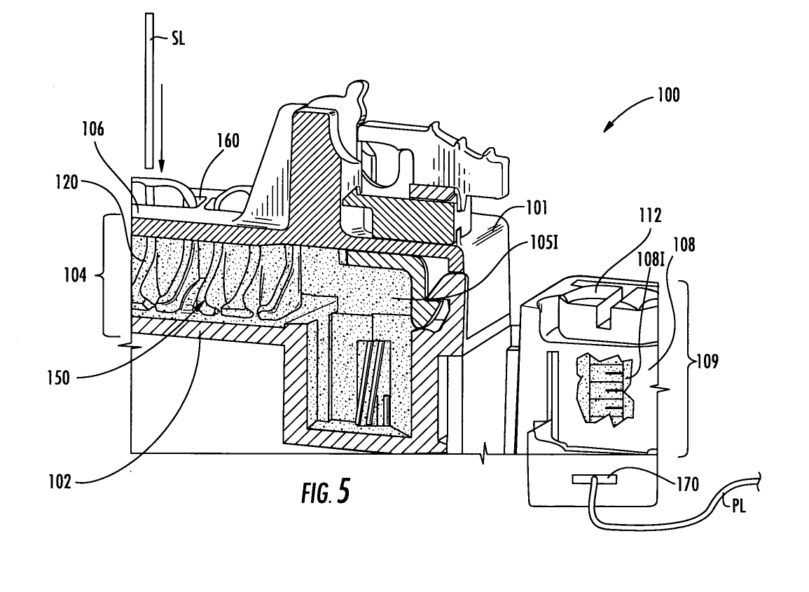

FIG. 4 is schematic interior view of the universal network interface device (NID) 80. NID 80 serves the function of isolating the provider portion of the telecommunication system or wiring from that of the respective system subscribers. Conventional NIDs generally include a container 82, the interior 88 of which includes at least one telecommunication interconnect device 100 that generally operates to connect the subscriber wiring to the provider wiring.

FIG. 5 is an enlarged partial cut-away diagram of telecommunication interconnect device 100 of FIG. 4 in which silicone gel 150 of the present invention is contained in one or more internal chambers of the device. Interconnect device 100 may be any apparatus or device for interconnecting provider lines with subscriber lines, such as a subscriber line module (“SLM”), protected terminating device (“PTD”), or the like. The particular interconnect device 100 shown in FIG. 5 for the sake of illustration is called an insulation displacement connector (IDC) module, or alternatively, a “line module.”

The interconnect device 100 generally includes a housing 101, a base 102, and a customer bridge 104 mounted on the base. Customer bridge 104 is commonly referred to in the art as an “interconnect module,” a “connector module,” or a “wiring module.” As used herein, the term “customer bridge” is intended to include any apparatus for terminating wiring in a communications network, including but not limited to, an interconnect module, a connector module, a wiring module, or a customer bridge.

Customer bridge 104 includes a cover 106 that can be opened and closed. Cover 106 and base 102 defines a customer-side interior chamber 105I. Customer bridge 104 is connected to a stuffer assembly 109 that includes a stuffer box 108 that defines a stuffer box interior chamber 108I.

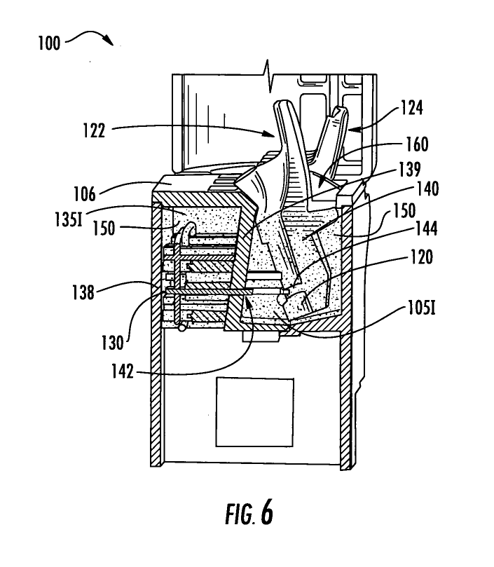

FIG. 6 is a close-up cross-sectional end-on view of customer bridge 104 similar to that of FIG. 5. Electrical connection device 100 of FIG. 6 includes a plurality of actuating arms 120, with one arm shown in a disconnected position 122 and one arm shown in a connected position 124. Arms 120 reside mostly in customer-side interior chamber 105I. An insulation displacement connector (IDC) 130 resides within a service-provider-side interior chamber 135I defined by cap 106, a housing sidewall 138 and an internal wall 139 that separates the service-provider-side chamber from the customer-side chamber. IDC 130 extends from service-provider-side interior chamber 135I to customer-side interior chamber 105I via slots 142 in internal wall 139. Each actuating arm 120 includes an opening 144 to receive a corresponding IDC 130.

Telecommunication interconnect device 100 includes silicone gel 150 of the present invention contained in at least one of the customer-side interior chamber 105I, service-provider-side interior chamber 135I, and stuffer box interior chamber 108I, so that any wires introduced into these chambers pass through silicone gel 150 and are surrounded by (coated with) the gel. The gel also serves to protect the various parts and internal surfaces residing in these chambers, including any electrical connection members. In an example embodiment, silicone gel 150 is inserted into one or more of the chambers via openings (e.g., openings 160 and 170, discussed below) in device housing 101.

When an actuating arm 120 is placed in the “disconnect” position, a subscriber line (wire) SL can be inserted into a wire insertion hole 160 and thus through silicone gel 150 contained in interior customer-side chamber 105I. The actuating arm is then moved from the “disconnect” position to the “connect” position to force the subscriber line SL into engagement with the IDC and thereby electrically connect the subscriber line SL to the customer bridge 104 of the line module 100.

With reference again to FIG. 5, a provider line (wire) PL is inserted into a horizontally disposed wire insertion passage 170 formed in stuffer box 108 and through an opening formed in the upper portion of the IDC. Provider line PL is thus coated with gel 150 as it passes through stuffer box 108. Securing screw 112 serves to bring the provider line PL into contact with a corresponding IDC (not shown in FIG. 5) to establish an electrical connection with telecommunication interconnect device 100 and thus between the provider line PL and the service line SL. Naturally, a plurality of provider lines and service lines can be connected using telecommunication interconnect device 100.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A silicone-based gel for use with a telecommunication device, comprising:
a) a Part A that includes (i) between about 15 to 20 parts vinyl terminated polydimethyl siloxane of non-agglomerated SiO₂ (nanocone) nanoparticles, (ii) between about 80 to 85 parts unmodified polydimethylsiloxane, and (iii) between about 0.1 to 0.3 parts of approximately 0.5% platinum catalyst; and
b) a Part B that includes (i) between about 5 to 10 parts vinyl terminated polydimethyl siloxane of non-agglomerated SiO₂ (nanocone) nanoparticles, (ii) between about 15 to 30 parts hydride terminated polydimethylsiloxane, (iii) between about 0.2 to 10 parts hydride functional polydimethylsiloxane, and (iv) between about 50 to 80 parts unmodified polydimethylsiloxane; and
c) wherein the gel generally defines a one-to-one ratio by weight or volume of Part A to Part B.

2. The silicone-based gel of claim 1, wherein Part A further includes less than one part of gamma-glycidoxypropyltrimethoxysilane.

3. The silicone-based gel of claim 1, wherein the gel defines a pot life at 25° C. of about 15 minutes.

4. The silicone-based gel of claim 1, wherein the gel defines a tensile stress at break of about 7.76 kPa.

5. The silicone-based gel of claim 1, wherein the gel defines a mean elongation in % in the range from about 1082 to about 1140.

6. The silicone-based gel of claim 5, wherein the gel defines a mean elongation in % of about 1124.

7. The silicone-based gel of claim 1, wherein the gel defines a cone penetration reading for a ¼-scale cone of 9.4 mm.

8. The silicone-based gel of claim 1, wherein Part A includes (i) 18.1 parts vinyl terminated polydimethyl siloxane of non-agglomerated SiO₂ (nanocone) nanoparticles, (ii) 81.7 parts unmodified polydimethylsiloxane, and (iii) 0.2 parts of approximately 0.5% platinum catalyst.

9. The silicone-based gel of claim 8, wherein Part B includes (i) 7.8 parts vinyl terminated polydimethyl siloxane of non-agglomerated SiO₂ (nanocone) nanoparticles, (ii) 18.1 parts hydride terminated polydimethylsiloxane, (iii) 0.4 parts hydride functional polydimethylsiloxane, and (iv) 73.7 parts unmodified polydimethylsiloxane.

10. An electrical interconnect for connecting to at least one conducting wire, comprising:
a housing defining at least one interior chamber, wherein the at least one electrical connection member is at least partially disposed within the at least one interior chamber; and
a silicone gel contained within at least a portion of the at least one interior chamber such that the gel contacts the at least one electrical connecting member; and
wherein the silicone gel comprises:
a) a Part A that includes (i) between about 15 to 20 parts vinyl terminated polydimethyl siloxane of non-agglomerated SiO₂ (nanocone) nanoparticles, (ii) between about 80 to 85 parts unmodified polydimethylsiloxane, and (iii) between about 0.1 to 0.3 parts of approximately 0.5% platinum catalyst; and
b) a Part B that includes (i) between about 5 to 10 parts vinyl terminated polydimethyl siloxane of non-agglomerated SiO₂ (nanocone) nanoparticles, (ii) between about 15 to 30 parts hydride terminated polydimethylsiloxane, (iii) between about 0.2 to 10 parts hydride functional polydimethylsiloxane, and (iv) between about 50 to 80 parts unmodified polydimethylsiloxane; and
c) wherein the gel generally defines a one-to-one ratio by weight or volume of Part A to Part B.

11. The device of claim 10, wherein the electrical connection member includes an insulation displacement connector.

12. The device of claim 10, wherein the at least one conducting wire is electrically connected to the at least one electrical connection member and is at least partially coated with the silicone gel.

13. The device of claim 12, wherein the at least one conducting wire is either a service line or a provider line.

14. The device of claim 10, wherein the housing includes at least one opening through which the at least one conducting wires can be inserted to make electrical contact with the at least one electrical connection member, and wherein the at least one conducting wire passes through the silicone gel to reach the at least one electrical connection member.

15. A method of manufacturing a telecommunication interconnect device for connecting one or more conducting wires, the method comprising:
providing a device housing that defines at least one interior chamber;
providing at least one electrical connection member at least partially within the at least one interior chamber, wherein the electrical connection member is adapted to provide an electrical connection with the one or more wires;
inserting a silicone gel within at least a portion of the at least one interior chamber such that the silicone gel contacts at least a portion of the at least one electrical connection member; and
wherein the silicone gel comprises:
a) a Part A that includes (i) between about 15 to 20 parts vinyl terminated polydimethyl siloxane of non-agglomerated SiO₂ (nanocone) nanoparticles, (ii) between about 80 to 85 parts unmodified polydimethylsiloxane, and (iii) between about 0.1 to 0.3 parts of approximately 0.5% platinum catalyst; and
b) a Part B that includes (i) between about 5 to 10 parts vinyl terminated polydimethyl siloxane of non-agglomerated SiO₂ (nanocone) nanoparticles, (ii) between about 15 to 30 parts hydride terminated polydimethylsiloxane, (iii) between about 0.2 to 10 parts hydride functional polydimethylsiloxane, and (iv) between about 50 to 80 parts unmodified polydimethylsiloxane; and
c) wherein the gel generally defines a one-to-one ratio by weight or volume of Part A to Part B.

16. The method of claim 15, wherein the device housing includes one or more openings formed therein and accessible to the at least one interior chamber, and including inserting the silicone gel into the at least one interior chamber through at least one of the one or more housing openings.

17. The method of claim 15, including providing the electrical connection member with an insulation displacement member.

18. The method of claim 15, including electrically connecting at least one of the electrical conducting wires to the at least one electrical connection member by passing the at least one electrical conducting wire through the silicone gel.

19. The method of claim 15, further including providing to Part A less than one part of gamma-glycidoxypropyltrimethoxysilane.

20. The method of claim 15, including forming the gel so that:
Part A includes (i) 18.1 parts vinyl terminated polydimethyl siloxane of non-agglomerated SiO₂ (nanocone) nanoparticles, (ii) 81.7 parts unmodified polydimethylsiloxane, and (iii) 0.2 parts of approximately 0.5% platinum catalyst; and
Part B includes (i) 7.8 parts vinyl terminated polydimethyl siloxane of non-agglomerated SiO₂ (nanocone) nanoparticles, (ii) 18.1 parts hydride terminated polydimethylsiloxane, (iii) 0.4 parts hydride functional polydimethylsiloxane, and (iv) 73.7 parts unmodified polydimethylsiloxane.
